(19) United States
(12) Patent Application Publication
(10) Pub. No.: US 2025/0011192 A1
(43) Pub. Date: Jan. 9, 2025

(54) NATURAL MINERAL-DERIVED LUMILITE ECOLOGICAL RESTORATION AGENT AND METHOD OF MANUFACTURING SAME

(71) Applicant: Kiho PARK, Daegu (KR)

(72) Inventor: Kiho PARK, Daegu (KR)

(21) Appl. No.: 18/890,802

(22) Filed: Sep. 20, 2024

Related U.S. Application Data
(63) Continuation of application No. PCT/KR2022/012467, filed on Aug. 19, 2022.

(30) Foreign Application Priority Data
Apr. 13, 2022 (KR) 10-2022-0046020
Apr. 13, 2022 (KR) 10-2022-0087865

(51) Int. Cl. C02F 1/28; B01J 20/12; B01J 20/30; C02F 1/52; C02F 3/34; C02F 103/00

(52) U.S. Cl. CPC C02F 1/281; B01J 20/12; B01J 20/3021; B01J 20/3078; C02F 1/288; C02F 1/5245; C02F 3/348; C02F 2103/007

(57) ABSTRACT

Disclosed are a natural mineral-derived Lumilite ecological restoration agent, including 65-75 wt % of clinoptilolite, 5-15 wt % of kaolinite, 3-10 wt % of montmorillonite, 2 wt % of laumontite, 2 wt % of perlite, 0.1 wt % of light rare earth, 0.01 wt % of neodymium, 0.01 wt % of dysprosium, 1-2 wt % of quartz, 5-9 wt % of pozzolan, 2-3 wt % of elvan, and equal proportions, 0.002-0.0033 wt %, of freeze-dried Dioscorea polystachya, freeze-dried polyglutamic acid (PGA), and freeze-dried palm sap, and a method of manufacturing the same, making it possible to protect water resources by preventing a rapid pH decrease in target water bodies, removing heavy metal toxicity of aluminum that is a cause of dementia, and preventing economic losses and serious reductions in ecological resilience, and to restore and maintain clean and safe first-class water quality in natural water bodies such as rivers, lakes, drinking water supply dams, groundwater, and the like.

### CROSS-REFERENCE TO RELATED APPLICATION

The application is a continuation of PCT/KR2022/012467, filed on Aug. 19, 2022, which is incorporated herein by reference in its entirety, and additionally claims priority to Korean Patent Application Number 10-2022-0046020 filed on Apr. 13, 2022 and Korean Patent Application Number 10-2022-0087865 filed on Apr. 13, 2022.

### BACKGROUND OF THE INVENTION

### Field of the Invention

The present invention relates to a natural mineral-derived Lumilite ecological restoration agent for use in rivers and lakes in polluted natural water bodies, and a method of manufacturing the same.

### Description of the Related Art

The main materials of natural silica sand, such as zeolite or bentonite, used in most water and soil pollution treatment, include a significant quantity of aluminum-based flocculants as auxiliary agents to increase the cation exchange capacity for flocculation of anionic turbid substances, or include algaecides, which are toxic chemicals that kill green algae.

However, there have been continuous issues raised, such as heavy metal toxicity of aluminum, which causes dementia, as side effects of the aluminum-based flocculants, and also the problem of the pH of the target water body rapidly dropping. Hence, the aluminum-based flocculants are mainly used in a limited manner in water purification plants or wastewater treatment plants. Although aluminum-based flocculants used when an algal bloom alert in which the number of toxic blue-green algae cells suddenly increases to at least 1 million cells/ml is issued in natural water bodies such as rivers, lakes, drinking water supply dams, reservoirs, groundwater, and the like have some flocculation effects, the level of aluminum in drinking water far exceeds 0.2 mg/l, which is the main cause of secondary pollution due to destruction of the ecological environment by heavy metal toxicity of aluminum.

### CITATION LIST

### Patent Literature (Patent Document 1) Korean Patent Application Publication No. 10-2007-0008262 (Jan. 17, 2007)

### SUMMARY OF THE INVENTION

The present invention is intended to provide a natural mineral-derived Lumilite ecological restoration agent and a method of manufacturing the same, making it possible to protect water resources by preventing a rapid pH decrease in target water bodies due to water treatment agents, removing heavy metal toxicity of aluminum that is a cause of dementia in water bodies, and preventing economic losses and serious reductions in ecological resilience due to the loss of inorganic materials such as sand, gravel, and yellow soil necessary for natural ecological restoration along with malodorous organic matter during mass dredging to remove malodorous organic matter, and to restore and maintain ecologically clean and safe water quality in natural water bodies such as rivers, lakes, drinking water supply dams, groundwater, and the like, which are becoming increasingly polluted by the day.

The present invention provides a natural mineral-derived Lumilite ecological restoration agent, including 65 to 75 wt % of clinoptilolite, 5 to 15 wt % of kaolinite, 3 to 10 wt % of montmorillonite, 2 wt % of laumontite, 2 wt % of perlite, 0.1 wt % of light rare earth, 0.01 wt % of neodymium, 0.01 wt % of dysprosium, 1 to 2 wt % of quartz, 5 to 9 wt % of pozzolan, 2 to 3 wt % of elvan, 0.002 to 0.0033 wt % of freeze-dried Dioscorea polystachya, 0.002 to 0.0033 wt % of freeze-dried polyglutamic acid (PGA), and 0.002 to 0.0033 wt % of freeze-dried palm sap.

In addition, the present invention provides a method of manufacturing a natural mineral-derived Lumilite ecological restoration agent, including a first step of subjecting 65 to 75 wt % of clinoptilolite, 5 to 15 wt % of kaolinite, 3 to 10 wt % of montmorillonite, 2 wt % of laumontite, 2 wt % of perlite, 0.1 wt % of light rare earth, 0.01 wt % of neodymium, 0.01 wt % of dysprosium, 1 to 2 wt % of quartz, 5 to 9 wt % of pozzolan, 2 to 3 wt % of elvan, 0.002 to 0.0033 wt % of freeze-dried Dioscorea polystachya, 0.002 to 0.0033 wt % of freeze-dried polyglutamic acid (PGA), and 0.002 to 0.0033 wt % of freeze-dried palm sap to grinding and then sieving through 350 to 400 mesh, a second step of subjecting the powder completed in the first step to stirring at 110 to 130° C. for 5 minutes and then natural cooling in air at room temperature for 24 hours, a third step of subjecting the powder completed in the second step to stirring at 260 to 370° C. for 5 minutes and then natural cooling in air at room temperature for 24 hours, a fourth step of subjecting the powder completed in the third step to heating at 410 to 470° C. for 5 minutes and then natural cooling in air at room temperature for 24 hours, and a fifth step of subjecting the powder completed in the fourth step to stirring for 5 minutes, cooling for 24 hours, and then packaging.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 shows images of dominant phytoplankton species in Janghyun reservoir before and after application of the technique of the present invention; and

FIG. 2 shows images of dominant phytoplankton species in Uiam Lake (Gongjicheon) before and after application of the technique of the present invention.

### DETAILED DESCRIPTION OF THE INVENTION

The present invention relates to a natural mineral-derived Lumilite ecological restoration agent and a method of manufacturing the same.

Hereinafter, a detailed description will be given of the present invention.

Lumilite according to the present invention may include 65 to 75 wt % of clinoptilolite, which is selected from among natural zeolites and is excellent for water purification due to high adsorption capacity and ion exchange capacity, 5 to 15 wt % of kaolinite, 3 to 10 wt % of montmorillonite, which is a type of clay mineral in the monoclinic system, 2 wt % of laumontite, which is a type of zeolite belonging to the monoclinic system, 2 wt % of perlite made from pearlstone or obsidian, 0.1 wt % of light rare earth, 0.01 wt % of neodymium and 0.01 wt % of dysprosium as heavy rare earth elements, 1 to 2 wt % of quartz, 5 to 9 wt % of pozzolan, which is a type of concrete admixture made of mineral powder such as volcanic ash, 2 to 3 wt % of elvan, 0.002 to 0.0033 wt % of freeze-dried Dioscorea polystachya, 0.002 to 0.0033 wt % of freeze-dried polyglutamic acid (PGA) obtained from Cheonggukjang and Natto, and 0.002 to 0.0033 wt % of freeze-dried palm sap.

Lumilite according to the present invention is a water purification agent manufactured based on clinoptilolite, a microporous mineral naturally formed by hardening of volcanic lava, and when phosphorus (P), which causes green algae, and suspended solids (SS), which are the cause of water pollution, are adsorbed to the porous structure thereof by ion exchange, clinoptilolite, which has become heavy due to flocculation of phosphorus and suspended solids, settles to the bottom, improving water quality. By virtue of excellent adsorption properties of the ion-exchanged Lumilite, the water quality is improved by adsorbing, precipitating, and removing aquatic pollutants, such as planktons, which are the cause of green algae.

The present invention relates to a method of manufacturing a natural mineral-derived Lumilite ecological restoration agent, including a first step of subjecting 65 to 75 wt % of clinoptilolite, 5 to 15 wt % of kaolinite, 3 to 10 wt % of montmorillonite, 2 wt % of laumontite, 2 wt % of perlite, 0.1 wt % of light rare earth, 0.01 wt % of neodymium, 0.01 wt % of dysprosium, 1 to 2 wt % of quartz, 5 to 9 wt % of pozzolan, 2 to 3 wt % of elvan, 0.002 to 0.0033 wt % of freeze-dried Dioscorea polystachya, 0.002 to 0.0033 wt % of freeze-dried polyglutamic acid (PGA), and 0.002 to 0.0033 wt % of freeze-dried palm sap to grinding and then sieving through 350 to 400 mesh, a second step of subjecting the powder completed in the first step to stirring at 110 to 130° C. for 5 minutes and then natural cooling in air at room temperature for 24 hours, a third step of subjecting the powder completed in the second step to stirring at 260 to 370° C. for 5 minutes and then natural cooling in air at room temperature for 24 hours, a fourth step of subjecting the powder completed in the third step to heating at 410 to 470° C. for 5 minutes and then natural cooling in air at room temperature for 24 hours, and a fifth step of subjecting the powder completed in the fourth step to stirring for 5 minutes, cooling for 24 hours, and then packaging.

In the present invention, clinoptilolite contains 67 to 68 wt % of silica (SiO₂), 11 to 14 wt % of aluminum oxide (Al₂O₃), 1 to 1.67 wt % of iron oxide (Fe₂O₃), 0.6 to 0.7 wt % of magnesium oxide (MgO), 2 to 3.42 wt % of calcium oxide (CaO), 1 to 1.25 wt % of sodium oxide (Na₂O), 2.92 wt % of potassium oxide (K₂O), and 0.064 wt % of zinc oxide (P₂O₅), and has a very high cation exchange capacity (CEC) of 140 to 155 (meg/100 g).

Furthermore, clinoptilolite is structurally negatively charged (−) by destroying the balance of negative (−) and positive (+) charges due to partial substitution of Si⁴⁺with Al³⁺in the tetrahedron, and the negatively charged (−) surface thereof becomes positively charged (+) by cation exchange, so the surface cations have the effect of being easily exchangeable with other surrounding cations, and thus the cation exchange capacity is high, but anion exchange is also possible.

Therefore, clinoptilolite is a mineral that is widely used as an additive, such as a catalyst, adsorbent, detergent, etc. because it has the function of removing foul odors by enabling good substitution of nitrogen oxide present in a gaseous state, detoxifying active oxygen through anion exchange, and contributing to the neutralization of pollutants. Bonding of constituent atoms in solid oxides is unique, so the properties of the constituent atoms do not change even when heated, and the basic unit is TO4 centered on a silicon or aluminum atom, which is very simple, but configurations that may be created by three-dimensional bonding thereof are diverse, and clinoptilolite is a crystalline complex oxide in which a silicon or aluminum atom binds to oxygen atoms to form a regular tetrahedral coordination structure.

Also, the surface exposed to the outer portion of grains regardless of pores is called the outer surface, and the surface of the pores is called the inner pore surface. Although clinoptilolite is a fine powder, the inner pore surface is very large, and is mostly used when functioning as an adsorbent or catalyst. It does not break even when heated or exhausted.

Kaolinite has a general chemical formula of Al₂Si₂O₅(OH)₄ and is referred to by various names depending on the crystal structure thereof. For example, kaolinite is referred to as kaolinite, halloysite, dickite, nacrite, etc. Kaolinite aids sedimentation of microorganisms and serves as a limiting source of nitrifying microorganisms in a biological reactor, thereby helping the activity of nitrifying microorganisms. Specifically, kaolinite supplies trace elements necessary for the growth and energy metabolism of nitrifying microorganisms, thereby accelerating the growth rate and promoting energy metabolism. In particular, this component has to be used in the treatment process under the condition that water content is maintained at less than 35% at the time of injection, and as this fraction increases, the efficiency may decrease. Accordingly, a drying time of 2 hours or more is required. The components thus selected may be utilized as microbial supports. Specifically, for the nitrifying microorganisms, growth may be efficiently induced not only by a suspended sludge system but also with adherent growth microorganisms in a process in which SRT (sludge retention time) is long, resulting in a quantitative increase in these components.

Montmorillonite is a type of refractory clay and is a SiO₂-Al₂O₃ mineral containing about 59% SiO₂, about 14% Al₂O₃, and about 3.5% Na₂O. Montmorillonite is widely distributed in feldspar or clay minerals in Korea, and when used together with zeolite group minerals, montmorillonite has a complementary effect through ion exchange and adsorption due to porosity, which are characteristics of SiO₂-Al₂O₃ minerals.

Also, although montmorillonite is not soluble in water, it has the property of absorbing water in an aqueous solution and swelling to about 8 to 12 times the particle size thereof, thereby complementing the adsorption of pollutants. As a high-CEC clay mineral, montmorillonite has a large surface area and excellent cation exchange capacity (CEC) among clay minerals, allowing water to pass freely between crystal units, so it is able to expand and contract depending on the water content. Montmorillonite also has a bacteriostatic effect, preventing algae from re-growing in the settled sediment.

Laumontite is created in cavities or fractures in basic igneous rocks such as basalt or volcanic tuff, and sometimes exists as a secondary mineral in granite and gneiss. Laumontite is also produced in gold veins and other mineral veins. Bonds between atoms are loose in view of crystal structure, and thus, even if the water filling the gaps therebetween is released under extreme heat, the skeleton remains intact, so other particulate matter may be adsorbed. By virtue of this property, laumontite is used as an adsorbent and as a molecular sieve to separate particulate matter of different sizes.

Perlite is an adsorbent that has a large specific surface area and is easy to attach microorganisms to a reactor. By forming a carrier using perlite that is lightweight and has high porosity, microorganisms are present in a form of being evenly adsorbed to the surface and inner pores of perlite, facilitating formation of microbial colonies and aiding stable growth of microorganisms, ultimately providing a carrier with excellent sedimentation ability as it is resistant to environmental changes such as temperature, water, and pH.

Perlite is made by crushing pearlstone, obsidian, etc. followed by baking at about 1,000° C. to form a porous structure.

Rare earth elements are classified into light rare earth elements and heavy rare earth elements, and light rare earth, neodymium, and dysprosium are used. Rare earth is a natural clay component and thus has no effect on the aquatic ecosystem. By removing the pollutant phosphorus through the adsorption and sedimentation mechanism, rare earth prevents eutrophication of rivers and lakes and fundamentally blocks occurrence of green algae. In particular, the phosphorus removal function is not limited to a short period of time, but may work in the water for 2 to 3 years to catch the inflowing phosphorus, making it economical and convenient to use.

Quartz is a type of silicate mineral with a silica content of at least 95 to 97 wt %. Quartz plays a role in water purification and oxygen supply to water. Also, quartz radiates far infrared rays and has deodorizing and antibacterial effects, and is effective at turning the water into alkaline water.

Pozzolan contains highly active silica, which binds to Ca (OH)₂ to form C—S—H.

Elvan is a medicinal stone belonging to the quartz porphyry and belongs to granodiorite porphyry among igneous rocks. The main components thereof are anhydrous silica and aluminum oxide, with a small amount of ferric oxide. Also, since elvan has strong adsorption properties with 30,000 to 150,000 pores per cubic centimeter, it is able to adsorb and remove toxic substances or suspended solids contained in water, and also, due to the function of exchanging ions with heavy metals, elvan is capable of removing harmful metals and is used as a water purification agent.

Freeze-dried Dioscorea polystachya, polyglutamic acid (PGA), and palm sap, which are used in equal proportions, are rich in vegetable tannins, so that residual formaldehyde may be obtained at low concentrations (e.g.:<500 ppm) by derivatization through typical phenol/aldehyde or Mannich reaction to improve water quality again, and are mixed with alum and iron (II) (III) chloride, which are inorganic flocculants, to prepare a wastewater treatment agent containing vegetable components, whereby difficult-to-decompose wastewater such as dyeing wastewater, leather wastewater, and food wastewater may be easily flocculated and settled to form insoluble sediments and purify water. In particular, pigments contained in wastewater are flocculated and removed, and also solid waste (shaving scrap) is fixed by binding of vegetable tannins thereto. Typically, vegetable tannins have multiple structurally adjacent phenolic hydroxyls, advantageously exhibiting a special affinity for most metal ions. Therefore, vegetable tannins may be usefully applied as an adsorbent component for removing various metal ions from aqueous solutions.

As is apparent from the foregoing, according to the present invention, a natural mineral-derived Lumilite ecological restoration agent has neither a rapid pH decrease in target water bodies nor heavy metal toxicity of aluminum that is a cause of dementia, and depending on the concentration of pollutants, the ecological restoration agent at a predetermined weight ratio is sprayed in a very small amount (100 to 200 ppm), improving the water quality of polluted natural water bodies over short or long periods of time. Moreover, since the ecological restoration agent is composed of natural minerals and has high particle strength, the composite natural silicon component of Lumilite having a specific gravity of 2.4 sinks to the bottom, and due to the high surface charge of the surface cations thereof, adsorbs and flocculates suspended solids in the water, and is then settled by gravity, and is deposited at about 1 mm on the bottom of the water, which is a sufficient covering thickness for suppressing the leaching of nutrients or heavy metals from the bottom sediment, maintaining a strong bridging state with the adsorbed suspended solids. Due to high particle strength, Lumilite acts as a shield to suppress the leaching of nutrients or heavy metals from the bottom sediment after sedimentation, thereby suppressing re-leaching, ultimately blocking occurrence of foul odors and leaching of the bottom sediment and decomposing organic matter that causes foul odors. Furthermore, the porous structure of Lumilite flocculated and settled on the bottom provides a habitat for microorganisms as aerobic bacteria that decompose malodorous organic matter in the bottom sediment, and thus Lumilite serves as a habitat and nutrient source for microorganisms as aerobic bacteria, allowing mass proliferation of vegetable microorganisms after sedimentation. These vegetable microorganisms act as decomposers of organic matter in the bottom sediment, naturally decomposing organic matter. After several months to half a year, a significant amount of the organic matter in the bottom sediment is decomposed, activating the bottom sediment condition and naturally restoring the bottom sediment. Therefore, the ecological restoration agent according to the present invention is excellent for reducing foul odors and improving bottom sediment quality, and can be applied to a wide range of various water quality sites with serious pollution. In addition, the ecological restoration agent according to the present invention protects the environment in a simple spray manner on polluted water surfaces rather than plant construction, and has the advantages of simple application, low cost, and high efficiency.

Meanwhile, based on results of analyzing the effects before and after water quality improvement and obtaining data by improving water quality using natural mineral-derived Lumilite as the natural water quality improvement agent of the present invention according to a water quality improvement cooperation project at Janghyun reservoir in Janghyun-dong, Gangneung-si, Gangwon-do, managed by the Korea Rural Community Corporation from Oct. 12, 2021 to Nov. 23, 2021, Janghyun reservoir in Gangneung showed a very poor (VI) water quality grade as of Sep. 29, 2021, with TOC (9.4 mg/l), turbidity (2,520 NTU), total phosphorus (0.453 mg/l), and chlorophyll a (107.7 mg/m³), requiring water quality management.

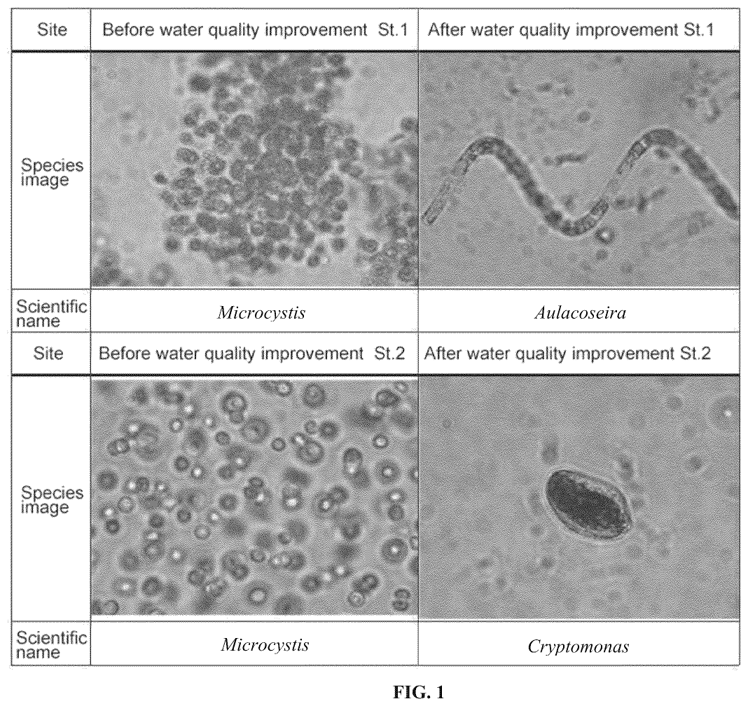

The water quality (COD, SS, TP, chlorophyll a, TOC, turbidity, and clarity) of Janghyun reservoir was greatly improved using Lumilite as the natural water treatment agent, and there was no ecological toxicity to water fleas and luminescent bacteria. Also, there was no impact on various groups of organisms, including fish and benthic macroinvertebrates.

<Experimental Example> All tests were conducted with 70 wt % of clinoptilolite, 10 wt % of kaolinite, 5 wt % of montmorillonite, 2 wt % of laumontite, 2 wt % of perlite, 0.1 wt % of light rare earth, 0.01 wt % of neodymium, 0.01 wt % of dysprosium, 1 wt % of quartz, 6 wt % of pozzolan, 2 wt % of elvan, 0.003 wt % of freeze-dried Dioscorea polystachya, 0.003 wt % of freeze-dried polyglutamic acid (PGA), and 0.003 wt % of freeze-dried palm sap (FIG. 1)

TABLE 1

| | | | 21.10.20 | 21.11.01 | 21.11.16 | 21.11.23 |
|---|---|---|---|---|---|---|
| | | | (after 8 | (after 20 | (after 35 | (after 42 |
| Analysis items | Unit | 21.10.12 | days) | days) | days) | days) |
| COD | mg/l | 23.4 | 3.2 | 2.8 | 0.6 | 0.8 |
| SS | mg/l | 79 | 26 | 16.8 | 3.7 | 2.6 |
| T-N | mg/l | 7.8 | 1.3 | 1.1 | 1.3 | 2 |
| T-P | mg/l | 0.429 | 0.109 | 0.078 | 0.015 | 0.015 |
| Conductivity | μS/cm | 144 | 111 | 116 | 152 | 186 |
| Chl.a | μg/1 | 128.6 | 12.6 | 6.8 | 0.3 | Not |
| | | | | | | detected |
| TOC | mg/l | 13.1 | 3.9 | 2.5 | 1 | 0.6 |
| Total | coliforms/100 ml | 540 | 4600 | 1400 | 79 | 170 |
| Coliforms | | | | | | |

<Water quality analysis results after spraying Lumilite of the present invention into Janghyun reservoir (Oct. 12, 2021)>

In addition, based on results of objectively analyzing the effects before and after water quality improvement and obtaining post-(environmental) impact assessment data by improving water quality using Lumilite as the natural water quality improvement agent of the present invention according to a water quality improvement cooperation project of the Korean Association for Aquatic Ecosystem Restoration and Korea Hydro & Nuclear Power in Uiam Lake (Gongjicheon), Chuncheon, from Oct. 21 to Dec. 11, 2021, Uiam Lake (Gongjicheon) in Chuncheon had high values for all water quality items at all sites as of Oct. 21, 2021, with SS at 3.3 to 4.7 mg/l, which is level II-III of the lake's living environment standard, T-P at 0.034, 0.018, 0.038, and 0.015 mg/l, which is level II-III of the lake's living environment standard, and chlorophyll a (Chl.a) at about 6 μg/l.

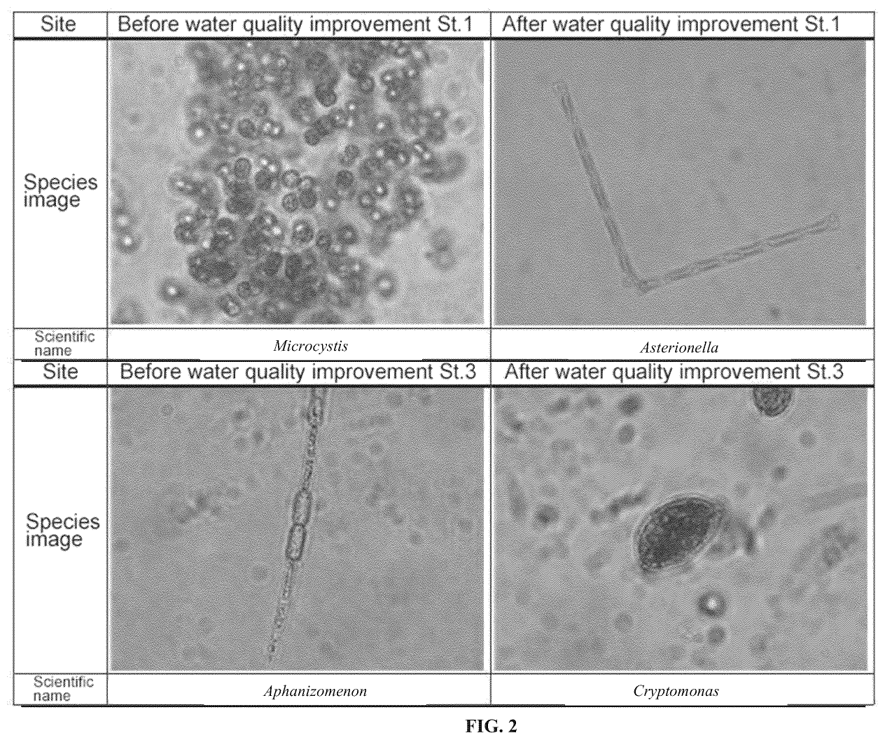

The water quality (COD, SS, TP, chlorophyll a, TOC, turbidity, and clarity) of Uiam Lake (Gongjicheon) in Chuncheon was also improved greatly using Lumilite as the natural water treatment agent, and there was no ecological toxicity to water fleas and luminescent bacteria. Also, there was no impact on aquatic organisms such as minnow (FIG. 2).

TABLE 2

| | | | 2021 Nov. 1 | 2021 Nov. 16 | 2021 Dec. 5 |
|---|---|---|---|---|---|
| Analysis items | Unit | 2021 Oct. 21 | (on day 12) | (on day 27) | (on day 46) |
| SS | mg/l | 3.3 | — | — | 0.6 |
| NH₃ —N | mg/l | 0.19 | 0.46 | 0.23 | 0.2 |
| NO₃ —N | mg/l | 1.3 | 1.8 | 1.6 | 0.6 |
| T-N | mg/l | 2.2 | 3.3 | 2.7 | 1.5 |
| T-P | mg/l | 0.034 | 0.042 | 0.065 | 0.009 |
| Chl. a | μg/l | 6.4 | 6.4 | 12.4 | 0.2 |
| TOC | mg/l | 2.6 | 2.7 | 3.4 | 0.9 |
| Total Coliforms | coliforms/100 ml | 4,600 | 1,600 | 9,200 | 920 |

<Water quality analysis results after spraying Lumilite of the present invention into Uiam Lake (Gongjichcon) (Oct. 21, 2021)>

What is claimed is:

1. A natural mineral-derived Lumilite ecological restoration agent, comprising 65 to 75 wt % of clinoptilolite, 5 to 15 wt % of kaolinite, 3 to 10 wt % of montmorillonite, 2 wt % of laumontite, 2 wt % of perlite, 0.1 wt % of light rare earth, 0.01 wt % of neodymium, 0.01 wt % of dysprosium, 1 to 2 wt % of quartz, 5 to 9 wt % of pozzolan, 2 to 3 wt % of elvan, 0.002 to 0.0033 wt % of freeze-dried Dioscorea polystachya, 0.002 to 0.0033 wt % of freeze-dried polyglutamic acid (PGA), and 0.002 to 0.0033 wt % of freeze-dried palm sap.

2. A natural mineral-derived Lumilite ecological restoration agent, comprising:
65 to 75 wt % of clinoptilolite containing 67 to 68 wt % of silica (SiO₂), 11 to 14 wt % of aluminum oxide (Al₂O₃), 1 to 1.67 wt % of iron oxide (Fe₂O₃), 0.6 to 0.7 wt % of magnesium oxide (MgO), 2 to 3.42 wt % of calcium oxide (CaO), 1 to 1.25 wt % of sodium oxide (Na₂O), 2.92 wt % of potassium oxide (K₂O), and 0.064 wt % of zinc oxide (P₂O₅);
5 to 15 wt % of kaolinite having a water content of less than 35 wt % by drying for 2 hours or more;
3 to 10 wt % of montmorillonite containing 59 wt % of SiO₂, 14 wt % of Al₂O₃, and 3.5 wt % of Na₂O;
2 wt % of laumontite;
2 wt % of perlite;
0.1 wt % of light rare earth;
0.01 wt % of neodymium;
0.01 wt % of dysprosium;
1 to 2 wt % of quartz;
5 to 9 wt % of pozzolan;
2 to 3 wt % of elvan;
0.002 to 0.0033 wt % of freeze-dried Dioscorea polystachya;
0.002 to 0.0033 wt % of freeze-dried polyglutamic acid (PGA); and
0.002 to 0.0033 wt % of freeze-dried palm sap.

3. The natural mineral-derived Lumilite ecological restoration agent of claim 1, wherein the quartz has a silica content of at least 95 to 97 wt %, the perlite is made by crushing pearlstone or obsidian followed by baking at 1,000° C. to form a porous structure, and the polyglutamic acid and the palm sap are mixed with alum and iron (II) (III) chloride, which are inorganic flocculants.

4. A method of manufacturing a natural mineral-derived Lumilite ecological restoration agent, comprising:
a first step of subjecting 65 to 75 wt % of clinoptilolite, 5 to 15 wt % of kaolinite, 3 to 10 wt % of montmorillonite, 2 wt % of laumontite, 2 wt % of perlite, 0.1 wt % of light rare earth, 0.01 wt % of neodymium, 0.01 wt % of dysprosium, 1 to 2 wt % of quartz, 5 to 9 wt % of pozzolan, 2 to 3 wt % of elvan, 0.002 to 0.0033 wt % of freeze-dried Dioscorea polystachya, 0.002 to 0.0033 wt % of freeze-dried polyglutamic acid (PGA), and 0.002 to 0.0033 wt % of freeze-dried palm sap to grinding and then sieving through 350 to 400 mesh;
a second step of subjecting a powder completed in the first step to stirring at 110 to 130° C. for 5 minutes and then natural cooling in air at room temperature for 24 hours;
a third step of subjecting the powder completed in the second step to stirring at 260 to 370° C. for 5 minutes and then natural cooling in air at room temperature for 24 hours;
a fourth step of subjecting the powder completed in the third step to heating at 410 to 470° C. for 5 minutes and then natural cooling in air at room temperature for 24 hours; and
a fifth step of subjecting the powder completed in the fourth step to stirring for 5 minutes, cooling for 24 hours, and then packaging.

5. A method of manufacturing a natural mineral-derived Lumilite ecological restoration agent, comprising:
a first step of subjecting 65 to 75 wt % of clinoptilolite containing 67 to 68 wt % of silica (SiO₂), 11 to 14 wt % of aluminum oxide (Al₂O₃), 1 to 1.67 wt % of iron oxide (Fe₂O₃), 0.6 to 0.7 wt % of magnesium oxide (MgO), 2 to 3.42 wt % of calcium oxide (CaO), 1 to 1.25 wt % of sodium oxide (Na₂O), 2.92 wt % of potassium oxide (K₂O), and 0.064 wt % of zinc oxide (P₂O₅), 5 to 15 wt % of kaolinite having a water content of less than 35 wt % by drying for 2 hours or more, 3 to 10 wt % of montmorillonite, 2 wt % of laumontite, 2 wt % of perlite, 0.1 wt % of light rare earth, 0.01 wt % of neodymium, 0.01 wt % of dysprosium, 1 to 2 wt % of quartz, 5 to 9 wt % of pozzolan, 2 to 3 wt % of elvan, 0.002 to 0.0033 wt % of freeze-dried Dioscorea polystachya, 0.002 to 0.0033 wt % of freeze-dried polyglutamic acid (PGA), and 0.002 to 0.0033 wt % of freeze-dried palm sap to grinding and then sieving through 350 to 400 mesh;
a second step of subjecting a powder completed in the first step to stirring at 110 to 130° C. for 5 minutes and then natural cooling in air at room temperature for 24 hours;
a third step of subjecting the powder completed in the second step to stirring at 260 to 370° C. for 5 minutes and then natural cooling in air at room temperature for 24 hours;
a fourth step of subjecting the powder completed in the third step to heating at 410 to 470° C. for 5 minutes and then natural cooling in air at room temperature for 24 hours; and
a fifth step of subjecting the powder completed in the fourth step to stirring for 5 minutes, cooling for 24 hours, and then packaging.

6. The method of claim 4, wherein the quartz has a silica content of at least 95 to 97 wt %, the perlite is made by crushing pearlstone or obsidian followed by baking at 1,000° C. to form a porous structure, and the polyglutamic acid and the palm sap are mixed with alum and iron (II) (III) chloride, which are inorganic flocculants.

7. The natural mineral-derived Lumilite ecological restoration agent of claim 2, wherein the quartz has a silica content of at least 95 to 97 wt %, the perlite is made by crushing pearlstone or obsidian followed by baking at 1,000° C. to form a porous structure, and the polyglutamic acid and the palm sap are mixed with alum and iron (II) (III) chloride, which are inorganic flocculants.

8. The method of claim 5, wherein the quartz has a silica content of at least 95 to 97 wt %, the perlite is made by crushing pearlstone or obsidian followed by baking at 1,000° C. to form a porous structure, and the polyglutamic acid and the palm sap are mixed with alum and iron (II) (III) chloride, which are inorganic flocculants.
